(19) United States
(12) Patent Application Publication
(10) Pub. No.: US 2026/0180355 A1
(43) Pub. Date: Jun. 25, 2026

(54) REMOVABLE AND PORTABLE POWER STATION

(71) Applicant: Toyota Motor Engineering & Manufacturing North America, Inc., Plano, TX (US)

(72) Inventor: Eric J. Connell, Dexter, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/990,856

(22) Filed: Dec. 20, 2024

(51) Int. Cl. H02J 7/00; B60R 11/00; H02J 7/34

(52) U.S. Cl. CPC H02J 7/971; B60R 11/00; H02J 7/342; H02J 7/751; B60R 2011/004; H02J 2207/20

(57) ABSTRACT

Methods, systems, and apparatus for a power station cavity built into a wall of a vehicle cargo bed. A vehicle includes the wall defining a portion of the vehicle cargo bed. The vehicle includes a vehicle power source (e.g., a vehicle battery, a fuel cell, etc.) configured to provide power to the vehicle. The built-in power station cavity is disposed in the wall and has an opening facing into the cargo bed. The power station cavity is sized and configured to receive a removable and portable power station. The power station cavity includes a vehicle electrical connector for receiving electrical power from the vehicle power source for charging the removable and portable power station. The removable and portable power station can include a processor for throttling electric current output depending on whether the portable power station is installed or removed from the power station cavity.

### BACKGROUND

### Field

The present disclosure relates generally to the field of vehicle equipment and, more particularly, to a built-in power station that maintains a removable and portable power station in a charged state.

### Description of the Related Art

Owners of vehicles (for example, pickup trucks) having cargo beds may use their vehicles for recreational purposes (such as camping, tailgating, or picnics), for construction or renovation projects, or for a variety of other purposes. Such activities may involve a user standing and working outside the cargo bed. Such activities may involve electrically powered devices.

Some electrically powered devices only have a limited duration between charging and may also take a substantial amount of time to charge. While electrically powered devices may be charged in a vehicle utilizing a USB or other appropriate port, the travel time spent in the vehicle before reaching a desired destination may not be sufficient to provide the portable electronic device with the desired charge before the individual must leave the vehicle and go to the required outside-the-vehicle destination.

Some electrically powered devices may not have onboard power storage and therefore require an external power supply to operate.

Accordingly, it is desirable to provide systems, methods, and techniques for convenient charging of electrically powered devices both in and near the cargo bed of the vehicle as well as any other outside-the-vehicle destination.

### SUMMARY

One aspect of the subject matter described in this disclosure may be embodied in a removable and portable power station for a wall of a vehicle cargo bed. The removable and portable power station can include a power bank housing, one or more batteries internal to the power bank housing, and one or more electrical receptacles. Each of the one or more electrical receptacles are configured to selectively provide electrical power from the one or more batteries to a plug that plugs into the electrical receptacle. The removable and portable power station can further include one or more circuits for performing tasks. The tasks can include determining that the portable power station is docked to a power station cavity of the wall of the vehicle cargo bed. The tasks can include, in response to determining that the portable power station is docked to the power station cavity of the wall of the vehicle cargo bed, limiting the electrical power from the one or more batteries to a first threshold current. The tasks can include determining that the portable power station is undocked from the power station cavity of the wall of the vehicle cargo bed. The tasks can include, in response to determining that the portable power station is undocked from the power station cavity of the wall of the vehicle cargo bed, limit the electrical power from the one or more batteries to a second threshold current, the second threshold current is less than the first threshold current.

In another aspect, the subject matter may be embodied in a vehicle. The vehicle can include a wall defining a portion of a cargo bed, a vehicle power source, and a built-in power station cavity disposed in the wall and having an opening facing the cargo bed. The built-in power station cavity is sized and configured to receive a removable and portable power station. The built-in power station cavity includes a vehicle electrical connector for receiving electrical power from the vehicle power source.

In another aspect, the subject matter may be embodied in a method throttling power output from a portable power station. The method can include determining that the portable power station is docked to a power station cavity of a wall of a vehicle cargo bed. The method can include, in response to determining that the portable power station is docked to the power station cavity of the wall of the vehicle cargo bed, limiting an electrical power from the one or more batteries to a first threshold current. The method can include determining that the portable power station is undocked from the power station cavity of the wall of the vehicle cargo bed. The method can include, in response to determining that the portable power station is undocked from the power station cavity of the wall of the vehicle cargo bed, limiting the electrical power from the one or more batteries to a second threshold current, the second threshold current is less than the first threshold current.

These and other aspects may optionally include one or more of the following features.

The one or more electrical receptacles can be defined by and integral to the power bank housing.

The removable and portable power station can further include a power bank electrical connector accessible from an exterior of the power bank housing and configured to connect to a vehicle electrical connector disposed in the wall of the vehicle cargo bed in response to the removable and portable power station being installed in the wall of the vehicle cargo bed.

The one or more batteries can be configured to receive electrical power from a vehicle power source via the power bank electrical connector when the removable and portable power station is installed in the wall of the vehicle cargo bed.

The power bank housing can include a front surface and a rear surface. The one or more electrical receptacles can be disposed at the front surface. The power bank electrical connector can be disposed at the rear surface.

The removable and portable power station can include a handle disposed at the front surface.

The removable and portable power station can include an inverter internal to the power bank housing.

The built-in power station cavity can be located at a rear half of the cargo bed.

The wall can be a sidewall at least partially defining a wheel well hump of the vehicle. The opening of the built-in power station cavity can be generally flush with the wheel well hump of the vehicle. The opening of the built-in power station cavity can be at least partially defined by the wheel well hump of the vehicle. The opening of the built-in power station cavity can be laterally offset from the wheel well hump of the vehicle. The built-in power station cavity can be spaced apart from the wheel well hump of the vehicle.

The vehicle can further include a cover disposed at the opening and configured to enclose the built-in power station cavity.

The vehicle power source can be configured to provide electrical power to charge the removable and portable power station via the vehicle electrical connector in response to the removable and portable power station being docked to the built-in power station cavity.

The vehicle can further include the removable and portable power station.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A is a schematic perspective view of a portion of a pickup truck including a built-in power station cavity defined by a sidewall of the pickup truck cargo bed, and having a tailgate in a closed position, according to an aspect of the invention.

FIG. 1B is a schematic perspective view of a portion of a pickup truck including a built-in power station cavity defined by a sidewall of the pickup truck cargo bed, and having a tailgate in an open position, according to an aspect of the invention.

FIG. 2 is a schematic cross-sectional view of the power station cavity built into the sidewall of the pickup truck cargo bed of FIG. 1B, according to an aspect of the invention.

FIG. 3A is a schematic cross-sectional view of a power station cavity built into a sidewall of a pickup truck cargo bed with a wheel well hump extended aft to increase a depth of the cavity, according to an aspect of the invention.

FIG. 3B is a schematic cross-sectional view of the power station cavity of FIG. 3A with a removable and portable power station being installed (or being removed) from the cavity, according to an aspect of the invention.

FIG. 3C is a schematic cross-sectional view of the power station cavity of FIG. 3A with the removable and portable power station installed (also referred to as docked) in the cavity, according to an aspect of the invention.

FIG. 4 is a flow or process diagram of a method for throttling a power output of a removable and portable power station, according to an aspect of the invention.

### DETAILED DESCRIPTION

Disclosed herein are systems, methods, devices, and/or vehicles for implementing a removable and portable power bank/power station for a vehicle. The vehicle includes a built-in power station defining a cavity (i.e., a docking station) configured to receive the portable power station. The cavity can be built into a wall of a cargo bed of the vehicle. The portable power station can receive electric power from a vehicle power source onboard the vehicle when the portable power station is docked to the built-in power station cavity. The portable power station can include one or more circuits configured to perform tasks, including throttling electric current output by the portable power station depending on whether the portable power station is docked with the built-in power station cavity and/or receiving power from the vehicle power source.

A removable and portable power station can be capable of powering camping equipment (e.g., air mattress inflator, tent fan, lights, etc.), tools (e.g., electric saws), home appliances, and/or any other electrically powered device (e.g., a stereo or TV for tailgating, etc.). The portable power station can dock directly into a cargo bed wall, so the portable power station continuously charges while the vehicle normally operates. The portable power station allows users to take it with them (e.g., A/C power “on-the-go”) by simply un-docking the power station. When docked, the portable power station acts as an inverter for A/C power. In this manner, the portable power station integrates with the onboard power source of the vehicle, keeping it fully charged until needed.

People who are camping, tailgating, or working construction spend a lot of time by truck beds. They need a place to charge their devices with minimal effort. To charge a phone for example, users typically must go inside their truck cab to use wireless or wired charging. A portable power station equipped with electrical outlets provides a convenient place to charge devices outside of the cab.

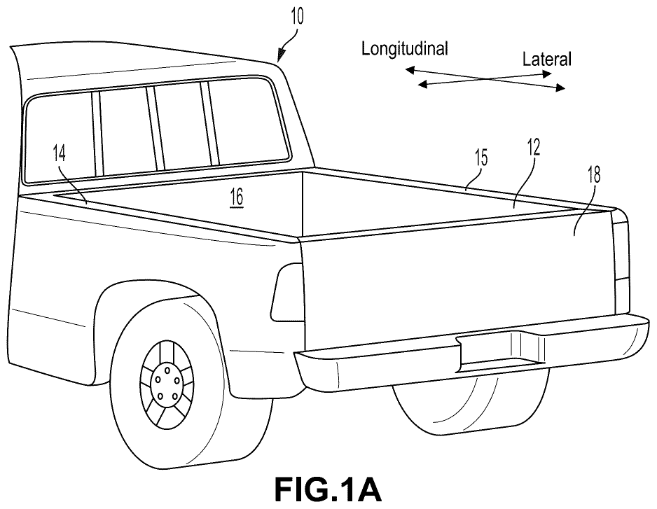

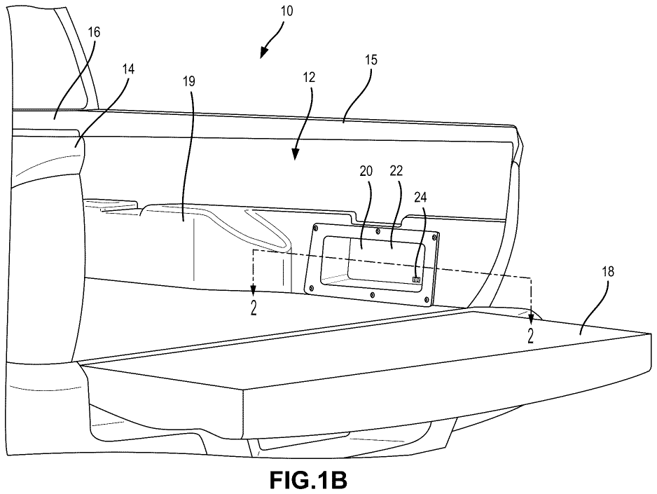

FIGS. 1-4 show various aspects possible features of a removable and portable power station for a wall defining a portion of a vehicle cargo bed. With reference to the drawings, the vehicle (generally designated by the reference numeral 10) is in the form of a pickup truck, and includes a cargo bed 12 defined by a floor and a plurality of walls surrounding the floor, which may include left and right sidewalls 14 and 15, respectively, a front wall 16, and a tailgate 18. However, aspects of the portable power station described herein may be mountable to cargo bed walls of vehicles other than pickup trucks. In various aspects, the cargo bed 12 can be further defined by one or more wheel well humps, such as wheel well hump 19. The vehicle 10 can be a fleetside vehicle with the wheel well humps 19 inside the cargo bed. The wheel well hump 19 can be a protuberance extending inward from the right sidewall 15 at the location of the wheel well of the vehicle 10. The wheel well hump 19 can be a portion of the vehicle structure that accommodates a wheel/tire of the vehicle 10. A portable power station as described herein may be mountable within a built-in power station cavity of any of the walls 14, 15, 16, and 18, in accordance with various aspects. The vehicle 10 of FIG. 1B shows an aspect of a built-in power station cavity 20 disposed in the sidewall 15 of the truck. However, the built-in power station cavity 20 may be disposed in at least any of the sidewall 14, the sidewall 15, the front wall 16, and/or the tailgate 18.

FIG. 1B is a perspective view of the built-in power station cavity 20 disposed in the sidewall 15 of the vehicle 10. The cavity 20 can be disposed in the rear half of the sidewall 15 (i.e., closer to the tailgate 18 than the front wall 16) to be accessible by a user standing on the ground near the tailgate 18. An opening 22 of the cavity 20 can face the interior of the cargo bed 12. The opening 22 of the cavity 20 can face the sidewall 14. An electrical connector 24 can be disposed in the cavity 20. The electrical connector 24 can be configured to electronically couple to the removable and portable power station (not shown) when the removable and portable power station is moved into the cavity 20 (i.e., automatically when the power station is installed or docked to the cavity 20).

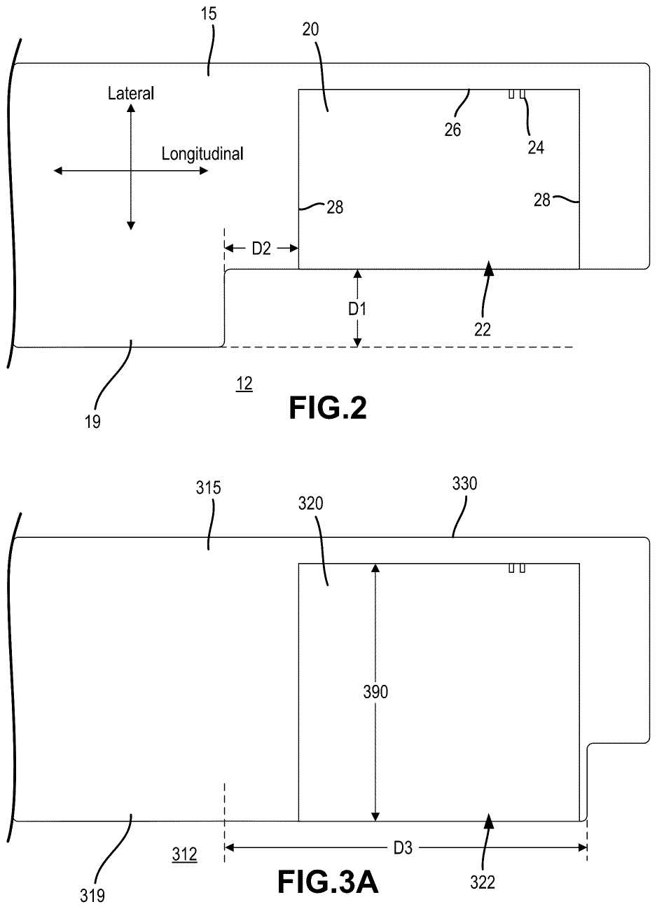

FIG. 2 is a section view of the cavity 20 disposed in the sidewall 15. In various aspects, the electrical connector 24 can be located on a back wall 26 of the cavity 20. However, the electrical connector 24 can also be located on a sidewall 28, a top wall, or a bottom wall of the cavity 20. The electrical connector 24 can be electrically coupled with a power source of the vehicle 10, such as a battery and/or a fuel cell (e.g., a hydrogen fuel cell). In this manner, the removable and portable power station can be charged when installed in the cavity 20.

In various aspects, the opening 22 of the cavity 20 is disposed further outboard from a longitudinal centerline of the vehicle 10 than the wheel well hump 19. For example, the wheel well hump 19 can extend further inboard from the opening 22 by a first distance D1. Stated differently, the opening 22 can be located outboard from the most inboard edge of the wheel well hump 19 by the first distance D1. In this manner, the opening 22 can be disposed laterally from the wheel well hump 19. The cavity 20 can be located aft of the wheel well hump 19 by a second distance D2.

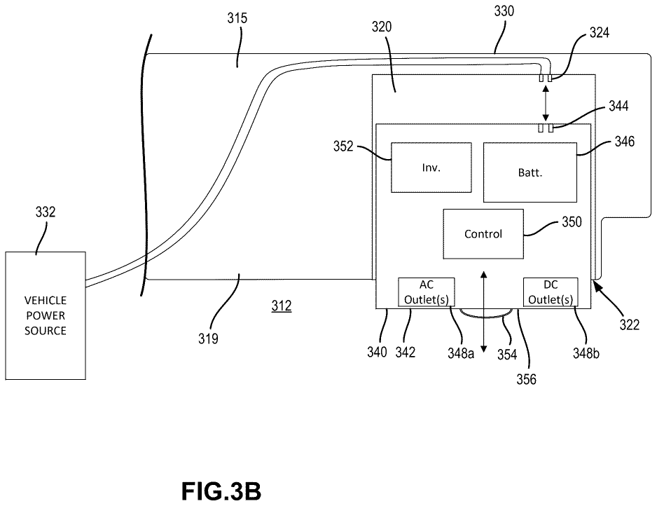

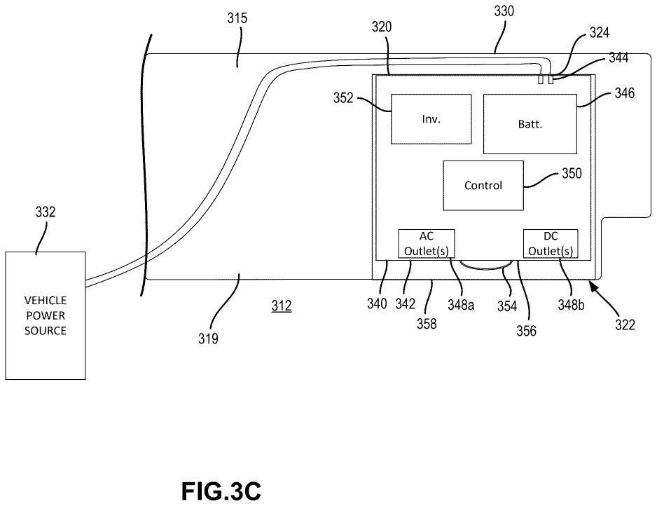

FIG. 3A is a schematic section view of a built-in power station cavity 320 disposed in a sidewall 315. The sidewall 315 can be similar to the sidewall 15 of FIG. 2, except that the wheel well hump 319 is extended aft to intersect with the cavity 320. The wheel well hump 319 can be extended aft of the wheel well by a third distance D3. In this manner, a depth 390 of the cavity 320 can be increased due to the opening 322 being located further inboard from the outer surface 330 of the sidewall 315 due to the space created by the wheel well hump 319. In this manner, the opening 322 can be generally flush with the wheel well hump 319.

FIG. 3B shows a removable and portable power station 340 being installed or removed from the cavity 320. The removable and portable power station 340 generally includes a power bank housing 342, an electrical connector 344 accessible from the exterior of the power bank housing 342, one or more batteries 346 internal to the power bank housing 342, one or more electrical receptacles (e.g., alternating current (AC) outlet(s) 348a, direct current (DC) outlet(s) 348b; referred to generally as electrical receptacles 348), one or more processors 350 for performing tasks, and an inverter 352. The electrical receptacles 348 can be defined by and integral to the power bank housing 342. The portable power station 340 can be moved laterally (with respect to the vehicle longitudinal axis) through the opening 322 to install and/or remove the portable power station 340 to/from the cavity 320. As the portable power station 340 is moved into the cavity 320, an electrical connector 344 of the portable power station 340 can contact the electrical connector 324 in the cavity 320 to charge a power source (e.g., the one or more batteries 346) in the portable power station 340. The electrical connector 324 can be electrically coupled to a vehicle power source 332 (e.g., a battery, a fuel cell, and/or any other suitable vehicle power source). In various aspects, the vehicle power source 332 is located externally from the sidewall 315 (e.g., mounted to a chassis of the vehicle under a passenger compartment and/or under a cargo bed of the vehicle). The one or more batteries 346 of the portable power station 340 can be charged by the vehicle power source 332 when the portable power station 340 is installed in the cavity 320 with the electrical connectors 344, 324 connected. FIG. 3B shows the removable and portable power station 340 just before the electrical connectors 344, 324 are connected (or just after the electrical connectors 344, 324 are disconnected).

The electrical receptacles 348 can be at least partially defined by, and integral to, the power bank housing 342. Each of the one or more electrical receptacles 348 can be configured to selectively provide electrical power from the one or more batteries 346 to any plug that plugs into the electrical receptacle 348. The one or more batteries 346 can include a lithium battery, a lithium-ion battery, and/or a lithium polymer battery, among others. The inverter 352 can include a DC-AC inverter configured to convert DC electricity from the one or more batteries 346 to AC electricity. The AC electricity can be provided to the AC outlets 348a. For example, the AC outlets 348a can be rated for 110-volt, 120-volt, 220-volt, 240-volt, or any other desired voltage AC electricity. However, the AC outlets 348a can be rated for any suitable voltage as desired. The inverter 352 can include a DC-DC converter configured to convert DC electricity from the one or more batteries 346 to DC electricity. The DC outlet(s) 348b can route DC voltage provided by the one or more batteries 346 to any plug that plugs into the DC outlet(s) 348b. The DC outlet(s) 348b can include any type of DC connector, such as USB, USB-C, a coaxial connector, or any other suitable connector. Additionally or alternatively, the removable and portable power station 340 may be configured with wireless recharging capability such that portable electrically powered devices may be recharged by the removable and portable power station 340 by placing the portable electrically powered devices in close proximity to the removable and portable power station 340 but without actually plugging the portable electrically powered devices into the power removable and portable power station 340.

The portable power station 340 can include a handle 354 at a front surface 356 thereof for pulling the portable power station 340 from the cavity 320. The handle 354 can also be used for carrying the portable power station 340, for pushing the portable power station 340 into the cavity 320, or any other handling of the portable power station 340. The electrical receptacles 348 can be disposed in the front surface 356 of the portable power station 340 so as to be accessible while the portable power station 340 is docked in the cavity 320.

In various aspects, the portable power station 340 includes the one or more processors 350 (referred to herein generally as a processor 350) and one or more tangible, non-transitory memories capable of implementing digital or programmatic logic. In various aspects, for example, the one or more processors 350 are one or more of a general-purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various aspects, the one or more processors 350 controls, at least various parts of, and operation of, various components of the portable power station 340. For example, the one or more processors 350 controls various parameters of power supply to or from the portable power station 340. The one or more processors 350 can be in electronic communication with the inverter 352.

In various aspects, the processor 350 can be configured to manage or throttle electrical current output and/or electrical power output of the portable power station 340 based on a docking status of the portable power station 340 (i.e., whether or not the portable power station 340 is docked in the cavity 320 and receiving electrical power from the vehicle power source 332). In various aspects, the portable power station 340 can be configured to power devices with large load (e.g., high amperage devices such as an electric saw or an electric water pump) when the portable power station 340 is docked in the cavity 320 since the power will be coming from the vehicle power source 332 via the inverter 352. In various aspects, the portable power station 340 can be limited to powering devices with smaller loads when the portable power station 340 is undocked from the cavity 320. For example, the processor 350 can limit the power output of the portable power station 340 to a first amperage and/or a first current when the portable power station 340 is docked in the cavity 320 and can limit the power output of the portable power station 340 to a second amperage and/or a second current (less than the first amperage and/or the first current, respectively) when the portable power station 340 is undocked from the cavity 320. In various aspects, the second amperage and/or the second current is less than half of the first amperage and/or the first current. By limiting the portable power station 340 to the second amperage and/or the second current when the portable power station 340 is undocked from the cavity 320, the life of the one or more batteries 346 can be extended.

FIG. 3C shows the removable and portable power station 340 installed or docked in the cavity 320. In various aspects, the front surface 356 is recessed in the opening 322 when the portable power station 340 is docked in the cavity 320. In various aspects, the front surface 356 is flush with the opening 322 when the portable power station 340 is docked in the cavity 320. In various aspects, the front surface 356 protrudes from the opening 322 when the portable power station 340 is docked in the cavity 320. The electrical connectors 344, 324 are in contact with one another when the portable power station 340 is installed in the cavity 320. While positioned within the cavity 320, the portable power station 340 may be plugged into the electrical connector 324 in order to recharge the one or more batteries 346 of the portable power station 340.

In various aspects, a cover 358 can be provided to enclose the cavity 320. The cover 358 can seal to the sidewall 315 to keep dust, moisture, and/or debris from entering the cavity 320. The cover 358 can be located at the opening 322 of the cavity 320.

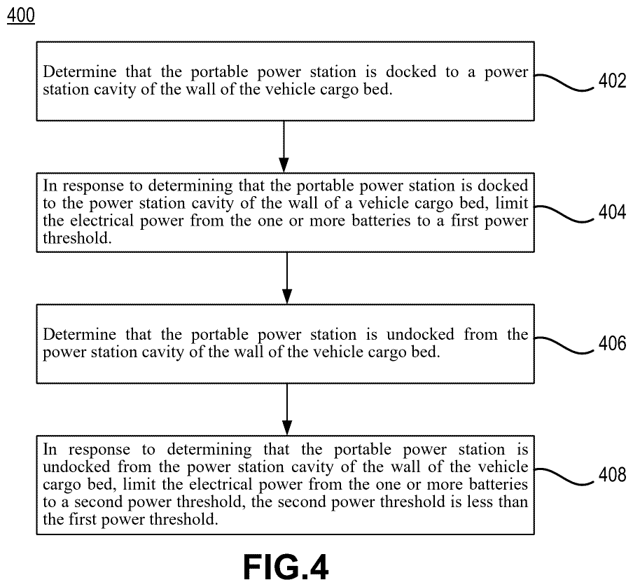

With reference to FIG. 4, a flowchart illustrating a method 400 is provided, in accordance with various aspects. In various aspects, the method 400 is a method for throttling a power output of a removable and portable power station. For ease of description, the method 400 is described below with reference to FIG. 3B and FIG. 3C. The method 400 of the present disclosure, however, is not limited to use of the exemplary built-in power station cavity 320 and removable and portable power station 340 of FIG. 3B and FIG. 3C.

In step 402, the method 400 includes determining that the portable power station 340 is docked with the power station cavity 320 of the wall 315 of the vehicle cargo bed 312 (see FIG. 3C). The processor 350 can determine that the portable power station 340 is docked with the power station cavity 320 by detecting a connection between the electrical connectors 324, 344 and/or by detecting electrical power input at the electrical connector 344.

In step 404, the method 400 includes, in response to determining that the portable power station 340 is docked to the power station cavity 320, limiting the electrical power from the one or more batteries 346 to a first threshold current. For example, the processor 350 can limit the power output via the electrical receptacles 348 to the first amperage and/or the first current.

In step 406, the method 400 includes determining that the portable power station 340 is undocked from the power station cavity 320 of the wall 315 of the vehicle cargo bed 312 (see FIG. 3B). The processor 350 can determine that the portable power station 340 is undocked from the power station cavity 320 by detecting a lack of connection between the electrical connectors 324, 344 and/or by detecting no electrical power input at the electrical connector 344.

In step 408, the method 400 includes, in response to determining that the portable power station 340 is undocked from the power station cavity 320, limiting the electrical power from the one or more batteries 346 to a second threshold current. The second threshold current is less than the first threshold current. For example, the processor 350 can limit the power output via the electrical receptacles 348 to the second amperage and/or the second current.

It is understood that the receptacles disclosed herein, including the number and types of receptacles included in the removable and portable power station, are only a few examples of countless possible receptacle configurations. For example, although the standard receptacles disclosed herein may be the North American NEMA 5-15 connectors, the universal receptacles disclosed herein may be designed to accept British plugs in addition to Euro, NEMA American and Australian plugs, and the USB receptacles disclosed herein may be standard USB 2.0 dedicated charging ports, it is understood that any other standard or nonstandard electrical receptacles may be employed. For example, electrical receptacles according to any of the following standards may be employed: NEMA 1-15 unpolarised; NEMA 1-15 polarised; JIS C 8303, Class II; NEMA 5-15; NEMA 5-20; NEMA 5-30; NEMA 5-50; NEMA 6-15; NEMA 6-20; NEMA 6-30; NEMA 6-50; NEMA 10-15; NEMA 10-20; NEMA 10-30; NEMA 10-50; NEMA 14-20; NEMA 14-30; NEMA 14-50; NEMA 14-60; JIS C 8303, Class I; CEE 7/16 (Europlug); CEE 7/17; GOST 7396 C 1; BS 4573; BS 546; CEE 7/5; CEE 7/4 Schuko; BS 1363; IS 401 & 411; MS 589; SS 145; SI 32; TIS 166-2549; AS/NZS 3112; CPCS-CCC; IRAM 2073; Swiss SEV 1011:2009/A1:2012 Typ 12 & Typ 13; Danish 107-2-D1; CEI 23-16/VII; South Africa SABS 164-1; Brazilian NBR 14136 (2 pin); Brazilian NBR 14136 (3 pin); South Africa SABS 164-2 (2 pin); South Africa SABS 164-2 (3 pin); USB 3.0; USB 3.1; USB-C (USB Type-C); USB On-The-Go (OTG); or some combination thereof. Also, a barrel plug may be employed. Further, any of the receptacles disclosed herein may additionally or alternatively be modular such that they may easily be switched out with other receptacles, depending on the standard receptacles in use in different parts of the world. Further, each of the “electrical receptacles” included in the removable and portable power station disclosed herein may additionally or alternatively be replaced with a corresponding “electrical plug” or cord that terminates in a corresponding “electrical receptacle” or “electrical plug” to allow electrically powered devices to be directly attached to this replacement to avoid the user having to carry electrical cords corresponding to each of the user's electronic devices. In other words, the “electrical plug” and/or corresponding “electrical cords” may be built into the power bank and/or docking station disclosed herein.

Exemplary aspects of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects that reasonably fall within the scope of the advancement to the art hereby contributed, and that that scope shall not be restricted, except in light of the appended claims and their equivalents.

Benefits, other advantages, and solutions to problems have been described herein with regard to specific aspects. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment,” “an embodiment,” “an example embodiment,” “various aspects,” “one aspect,” “an aspect,” “an example aspect,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A removable and portable power station for a wall of a vehicle cargo bed, the removable and portable power station comprising:
a power bank housing;
one or more batteries internal to the power bank housing;
one or more electrical receptacles, each of the one or more electrical receptacles configured to selectively provide electrical power from the one or more batteries to a plug that plugs into the electrical receptacle;
one or more circuits for performing tasks, the tasks including:
determining that the portable power station is docked to a power station cavity of the wall of the vehicle cargo bed;
in response to determining that the portable power station is docked to the power station cavity of the wall of the vehicle cargo bed, limiting the electrical power from the one or more batteries to a first threshold current;
determining that the portable power station is undocked from the power station cavity of the wall of the vehicle cargo bed; and
in response to determining that the portable power station is undocked from the power station cavity of the wall of the vehicle cargo bed, limiting the electrical power from the one or more batteries to a second threshold current, the second threshold current is less than the first threshold current.

2. The removable and portable power station of claim 1, wherein the one or more electrical receptacles are defined by and integral to the power bank housing.

3. The removable and portable power station of claim 1, further comprising a power bank electrical connector accessible from an exterior of the power bank housing and configured to connect to a vehicle electrical connector disposed in the wall of the vehicle cargo bed in response to the removable and portable power station being installed in the wall of the vehicle cargo bed.

4. The removable and portable power station of claim 3, wherein the one or more batteries is configured to receive electrical power from a vehicle power source via the power bank electrical connector when the removable and portable power station is installed in the wall of the vehicle cargo bed.

5. The removable and portable power station of claim 4, wherein the power bank housing includes a front surface and a rear surface, and the one or more electrical receptacles are disposed at the front surface.

6. The removable and portable power station of claim 5, wherein the power bank electrical connector is disposed at the rear surface.

7. The removable and portable power station of claim 5, further comprising a handle disposed at the front surface.

8. The removable and portable power station of claim 1, further comprising an inverter internal to the power bank housing.

9. A vehicle comprising:
a wall defining a portion of a cargo bed;
a vehicle power source; and
a built-in power station cavity disposed in the wall and having an opening facing the cargo bed, the built-in power station cavity is sized and configured to receive a removable and portable power station, the built-in power station cavity includes a vehicle electrical connector for receiving electrical power from the vehicle power source.

10. The vehicle of claim 9, wherein the built-in power station cavity is located at a rear half of the cargo bed.

11. The vehicle of claim 9, wherein the wall is a sidewall at least partially defining a wheel well hump of the vehicle.

12. The vehicle of claim 11, wherein the opening of the built-in power station cavity is generally flush with the wheel well hump of the vehicle.

13. The vehicle of claim 11, wherein the opening of the built-in power station cavity is at least partially defined by the wheel well hump of the vehicle.

14. The vehicle of claim 11, wherein the opening of the built-in power station cavity is laterally offset from the wheel well hump of the vehicle.

15. The vehicle of claim 12, wherein the built-in power station cavity is spaced apart from the wheel well hump of the vehicle.

16. The vehicle of claim 9, further comprising a cover disposed at the opening and configured to enclose the built-in power station cavity.

17. The vehicle of claim 9, wherein the vehicle power source is configured to provide electrical power to charge the removable and portable power station via the vehicle electrical connector in response to the removable and portable power station being docked to the built-in power station cavity.

18. The vehicle of claim 9, further comprising the removable and portable power station, the removable and portable power station includes a power bank housing, one or more batteries internal to the power bank housing, and one or more electrical receptacles, each of the one or more electrical receptacles configured to selectively provide electrical power from the one or more batteries to a plug that plugs into the electrical receptacle.

19. The vehicle of claim 18, wherein the removable and portable power station includes a power bank electrical connector configured to connect to the vehicle electrical connector in response to the removable and portable power station being moved into the built-in power station cavity.

20. A method for throttling power output from a portable power station, the method comprising:
determining that the portable power station is docked to a power station cavity of a wall of a vehicle cargo bed;
in response to determining that the portable power station is docked to the power station cavity of the wall of the vehicle cargo bed, limiting an electrical power from the one or more batteries to a first threshold current;
determining that the portable power station is undocked from the power station cavity of the wall of the vehicle cargo bed; and
in response to determining that the portable power station is undocked from the power station cavity of the wall of the vehicle cargo bed, limiting the electrical power from the one or more batteries to a second threshold current, the second threshold current is less than the first threshold current.
